(19) United States
(12) Patent Application Publication
(10) Pub. No.: US 2012/0288836 A1
(43) Pub. Date: Nov. 15, 2012

(54) God calling watch

(76) Inventor: Sonya Yvette Underwood, Fort Wayne, IN (US)

(21) Appl. No.: 13/135,163

(22) Filed: Jun. 27, 2011

Related U.S. Application Data
(60) Provisional application No. 61/484,468, filed on May 10, 2011.

(51) Int. Cl. G09B 19/00

(52) U.S. Cl. 434/245

(57) ABSTRACT

The Lord has revealed a solution to me which will strengthen, bring Unity and Oneness in the body of Christ. This method process will serve as a blueprint to Christians in all denominations. The process will help Christians to apply the instructions given repeatedly by God himself, woven throughout his word. The new use device of watches and the process applied to cellular phones, iPads and iPods will be used to exalt the word of God. Christians will now have a useful device to help them pull down strong holds, to cast down imaginations and everything that exalt it's self against the knowledge of God, and to bring every thought into captivity to the obedience of Christ. The device will be used to help teach righteousness and holiness in the body of Christ. Because of my reverence to the awesome power of God's word; I can say that a multitude of good and marvelous manifestations will begin to surface in the body of Christ. They are countless. I cannot name them all. All instructions in the process are found in the word of God. This Holy watch and process will be used to serve humanity. The device will empower Christians from every denomination regardless of age all around the world. The final result will be Holy Sanctification of the body of Christ [The bride]. Based upon, Revelations 19:7 and Genesis 11:6 causing our Lord and Savior to appear Jesus Christ.

### CROSS-REFERENCE TO RELATED APPLICATIONS

This application claims the benefit of provisional patent application Ser. No. 61/484,468, filed 2011 May 10 by the present inventor.

### FEDERALLY SPONSORED RESEARCH

Not Applicable

### SEQUENCE LISTING

Not Applicable

### OTHER REFERENCES

LeSEA, Holy Bible, King James Version, printed in 1962, by Thomas Nelson Inc.

Albert Einstein's theory of Relativity E=mc²

### BACKGROUND

### Prior Art

This invention pertains to watches. Watches have been used by humans throughout the years to help keep the seconds, minutes, hours, days and years. A new use watch is being introduced. A Holy watch will be used as an effective tool to exalt the word of God yielding a multitude of results within the body of Christ.

### SUMMARY OF INVENTION

Said watch will be used to exalt the word of God. Said watch will be for a new use consisting of several combinations and method processes. Said watch will be used to align, teach and serve as a well needed and helpful tool for Christians in the body of Christ; allowing them to sow God's word into their hearts and minds. Said watch and process will lead the way in assisting the body of Christ in Holy Sanctification; with the final result of causing our Lord and Savior to appear Jesus Christ.

### BRIEF DESCRIPTION OF THE DRAWING

FIG. 1 is a flow chart showing the steps of the method process and final results.

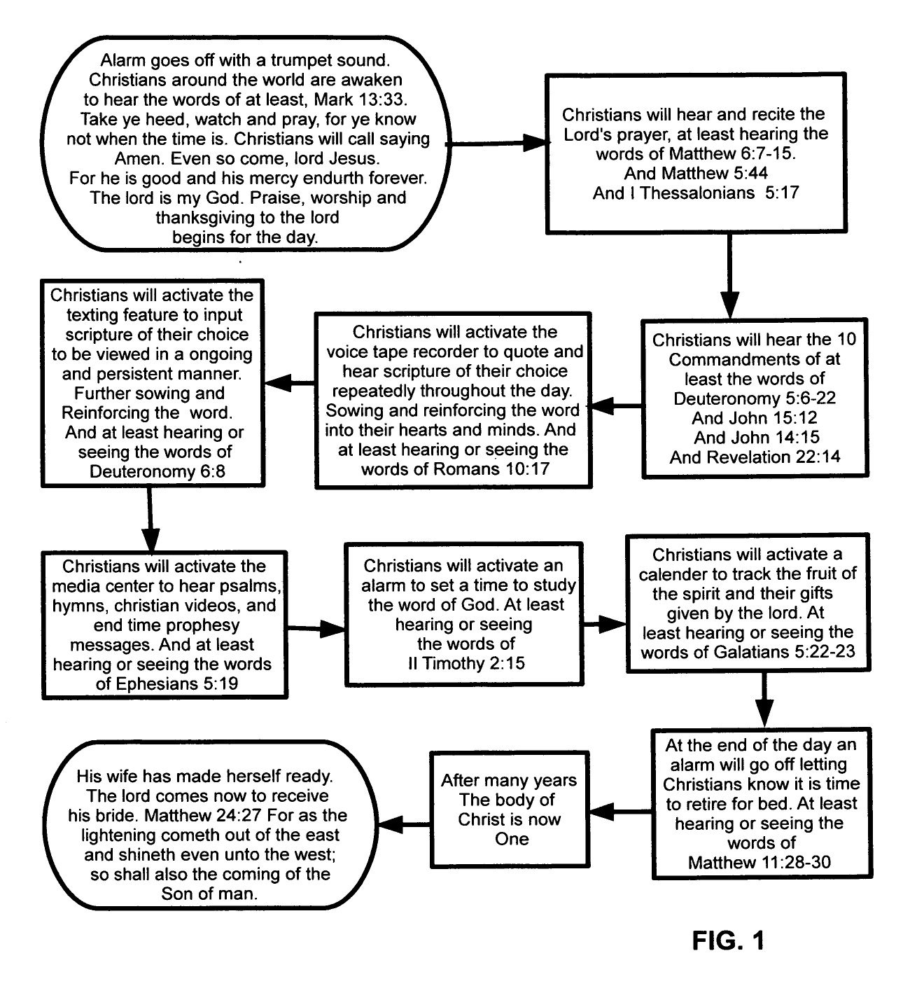

### DETAILED DESCRIPTION

This is a process and new use hardware method used to exalt the word of God. A watch comprising of the latest technology is used. The process will also be applied to cellular phones, iPads, and iPods as a purchased application, however not limited to just said devices; but the process may be applied to any other technical devices allowed. Christians will have the choice of wearing the watch on the wrist, worn around the neck, and to be able to have said watch to sit on a stand in their place of residence. Said watch and process will be beneficial to parents in teaching their children the word of God. Based upon, Deuteronomy 6:7. And thou shalt teach them diligently unto thy children, and shalt talk of them when thou sittest in thine house, and when thou walkest by the way, and when thou liest down, and when thou risest up.

Said new use holy watch, comprising:

With an alarm clock built into it.
Christians all around the world will be awaken every morning with the sound of a trumpet and at least hearing the words of Mark 13:33.Take ye heed, watch and pray: for ye know not when the time is.
Or at least hearing the words of Matthew 24:42. Watch therefore: for ye know not what hour your lord doth come.
Or at least hearing the words of Luke 12:40. Be ye therefore ready also: for the Son of man cometh at an hour when ye think not.
Christians will hear and CALL saying:
At least the words [COME]. Revelations 22:17
Or at least hear and Call saying. [Amen. Even so come, Lord Jesus]. Revelations 22:20
Saying thereafter, [For he is good; for his mercy endured forever. The lord is my God] based upon, II Chronicles 5:13-14. Zechariah 13:9. Christians will give praise, worship and thanks to the lord at any time during the process and always thereafter.

Christians will at least hear and recite the Lord's Prayer. Matthew 6:7-15. After this manner therefore pray ye: Our father which art in heaven. Hollowed be thy name. Thy kingdom come. Thy will be done in earth, as it is in heaven. Give us this day our daily bread. And forgive us our debts, as we forgive our debtors. And lead us not into temptation, but deliver us from evil: For thine is the kingdom, and the power, and the glory, forever. Amen. For if ye forgive men their trespasses, your heavenly Father will also forgive you: But if ye forgive not men their trespasses, neither will your Father forgive your trespasses.

And at least hearing the words of Matthew 5:44. But I say unto you. Love your enemies, bless them that curse you, do good to them that hate you, and pray for them which despitefully use you. And persecute you.
And at least hearing the words of I Thessalonians 5:17. Pray without ceasing.

The Ten commandments are heard or seen by Christians. At least hearing the words of; Deuteronomy 5:6-21. And at least hearing or seeing Jesus's new commandment of John 15:12. This is my commandment, that ye love one another, as I have loved you.

And at least hearing or seeing Matthew 22:36-40
Master, which is the great commandment in the law? Jesus said unto him, Thou shalt love the Lord thy god with all thy heart and with all thy soul and with all thy mind. This is the first and great commandment. And the second is like unto it. Thou shalt love thy neighbor as thy self. On these two commandments hang all the law and the prophets.
And at least hearing or seeing the words of John 14:15. If ye love me, keep my commandments.
And at least hearing or seeing the words of Revelation 22:14. Blessed are they that do his commandments, that they may have right to the tree of life, and may enter in through the gates into the city.

Said watch will have a built in voice tape recorder and headphone ear piece. Christians will be able to quote and hear the scripture of their choice; repeatedly throughout the day, by sowing and reinforcing the word into their hearts and minds based upon Romans 10:17.

So then faith cometh by hearing, and hearing by the word of God.

Said watch will have a texting feature so that Christians can input the scripture of their choice to be viewed in an ongoing and persistent manner. At least on said watch face, around face or band if they choose, further sowing and reinforcing the word into their hearts and minds. Based upon, Deuteronomy 6:8. And thou shalt bind them for a sign upon thine hand, and they shall be as frontlets between thine eyes. And Proverbs 6:21 bind them continually upon thine heart, and tie them about thy neck.

Said watch will have a media center for Christians to hear and see psalms, hymns and Christian music videos for all age groups. Based upon, Ephesians 5:19.

Speaking to yourselves in psalms and hymns and spiritual songs, singing and making melody in your hearts to the Lord.

Christians will be able to activate the media center to hear or see the current signs of the times. At least by short clips of news reports, short texting and emails that align with bible end time prophesy. Or at least hearing or seeing the words of Mark 13:28-29.

Now learn a parable of the fig tree; When her branch is yet tender, and putteth forth leaves, ye know that summer is near: So ye in like manner, when ye see these things come to pass, know that it is nigh, even at the doors.
Or at least hearing or seeing the words of Mark 13:32.
But of that day and that hour knoweth no man, no, not the angels which are in heaven, neither the Son, but the father.
Or at least hearing or seeing the words of Matthew 24:26.
Wherefore if they say unto you, Behold, he is in the desert: go not forth: behold, he is in the secret chamber; believe it not.

Christians will be able to activate the media center to view a memorial video of the alabaster box woman. At least hearing or seeing the words of Matthew 26:6-13. Or at least to have an engraving on said watch of the woman washing Jesus feet. [Important]

Verily I say unto you. Where so ever this gospel shall be preached in the whole world, there shall also this, that this woman hath done, shall be told for a memorial of her. This will be done to fulfill his wishes for this woman. The memorial will remind Christians to be forgiving and not to have a religious spirit.
Said watch will also have a memorial video of the crucifixion or cross and the importance of the power of the blood of Jesus. Said watch may also have an engraving of the cross. Christians will at least hear or see the words of I Corinthians 1:18. For the preaching of the cross is to them that perish foolishness; but unto us which are saved it is the power of God.
And at least hearing or seeing the words of Romans 6:1-2.
What shall we say then? Shall we continue in sin, that grace may abound? God forbid. How shall we, that are dead to sin, live any longer therein?
And at least hearing or seeing the words of Romans 6:18.
Being then made free from sin, ye became the servants of righteousness.

Said Watch will have an alarm for Christians to set, for their special appointed time to study the word of God. At least hearing or seeing the words of II Timothy 2:15.

Study to show thy self approved unto God, a workman that needed not to be ashamed, rightly dividing the word of truth.

Said watch will have a calendar or device for Christians to track the progress of their gifts given by the Lord, or a device to track the fruit of the spirit by hearing or seeing the words of Galatians 5:22-23.

But the fruit of the Spirit is love, joy, peace, longsuffering, gentleness, goodness, faith.
Meekness, temperance: against such there is no law.

At the end of the day a reminder alarm will sound, at the time requested by Christians that it is time to retire for bed. At least hearing or seeing the words of Matthew 11:28-30

Come unto me, all ye that labor and are heavy laden, and I will give you rest. Take my yoke upon you, and learn of me: for I am meek and lowly in heart: and ye shall find rest unto your souls. For my yoke is easy and my burden is light.

As the reader can see, this new Holy watch and process is most needed in the body of Christ. It is the whole Armor of God. It will be the first device to use the latest technology to exalt the word of God that Christians can keep on them, yielding an abundance of results. A problem once thought unsolvable, the said watch and process will bring the unity of the faith of all Christian based denominations, [Ephesians 4:13] therefore it will be in demand all around the world. It will make the body of Christ holy and righteous using God's instructions by helping Christians to focus on his word. Most important, this is about the Hope of His Calling; let us not make Him wait any longer. Based upon, Matthew 23:37 and Psalm 14:2.

### Ephesians 1:18

The eyes of your understanding being enlightened; that ye may know what is the Hope of His Calling, and what the riches of the glory of his inheritance in the saints.

### I Corinthians 7:20

Let every man abide in the same calling wherein he is called.

### Hebrews 3:1

Wherefore, holy brethren, partakers of the heavenly calling, consider the Apostle and High Priest of our profession, Jesus Christ.
Philippians 3:14 I press toward the mark for the prize of the high Calling of God in Christ Jesus.

What is claimed is:

1. A process method for christians to exalt the word of god, comprising:
a. recording the word of god and hearing the word of god repeatedly by said christians
b. seeing the word of god in an ongoing and persistent manner repeatedly by said christians
whereby exalting the word of god for said christians, thereby strengthing the faith, pulling down strong holds, and transforming the mind.

2. A process method of claim 1, wherein to bring the unity of the faith of all christian based denominations, further comprising;
a. hearing every morning to watch and to be ready by said christians of said denominations
b. saying every day to come lord jesus by said christians of said denominations
c. having one faith that our lord will appear by said christians of said denominations
d. reminding said christians that we are all one body in christ of said denominations
e. hearing and seeing the word of god repeatedly by said christians of said denominations
f. renewing the mind of said christians of said denominations
whereby bringing the unity of the faith, of all christian based denominations.

3. A process method of claim 1, wherein to teach christians how to pray, and how often, further comprising:
a. hearing and reciting the lord's prayer by said christians
b. hearing to pray without ceasing by said christians
c. reminding said christians to pray for others
d. hearing and seeing the word of god repeatedly by said christians
whereby teaching said christians how to pray and how often.

4. A process method of claim 1, wherein to remind christians to keep the 10 commandments, further comprising:
a. hearing the 10 commandments repeatedly by said christians
b. hearing jesus new commandment by said christians
c. hearing and seeing the greatest commandment by said christians
d. hearing if you love me keep my commandments by said christians
e. hearing blessed are they that do his commandments, that they may have right to the tree of life and may enter in through the gates into the city by said christians
whereby reminding christians to keep the 10 commandments.

5. A process method of claim 1, wherein to make disciples of christ, and to perfect the saints, further comprising:
a. reminding said christians to set time a side by way of study time alarm
b. hearing and seeing the word of god repeatedly by said disciples and saints
c. adhering to the full process by said christians allowing themselves to be set apart and made holy
whereby making disciples of christ and the perfecting of the saints.

6. A process method of claim 1, wherein for christian parents to help train up a child in the way they should go, further comprising:
a. speaking to their children on scripture of the day before leaving the home of said christian parents
b. making disciples of christ and saints early in life by utilizing study time tools and teaching them how to pray by said christian parents
c. making strong faith warriors of said children by them hearing and seeing the word of god repeatedly to help with everyday life by said christian parents
whereby said children will not depart from the faith because of the solid foundation based upon training by said christian parents.

7. A process method of claim 2, wherein to sanctify the body of christ, preparing the bride, further comprising:
a. hearing and seeing the word repeatedly by said body of christ
b. calling on the lord repeatedly by said body of christ
c. making christians aware that they are the bride
d. reminding christians to always be ready
whereby sanctifying the body of christ, thereby preparing the bride for the groom.

8. A process method of claim 1, wherein to bring a nation back to god, further comprising;
a. reminding said christians of all ages not to forget about god
b. sowing the word of god into the minds and hearts of all said christians regardless of age repeatedly
c. reminding said christians to keep the 10 commandments
d. reminding christians to treat others how you would like to be treated
whereby bringing a nation back to god, thereby blessing the nation.

9. A process method of claim 1, wherein to remind christians of the cross, and the blood of jesus, further comprising;
a. hearing and seeing repeatedly the importance of the cross and the blood of jesus of said christians
b. hearing and seeing memorial videos of said subject by said christians
c hearing and seeing the word of god repeatedly by said christians
d. hearing and seeing that said christians are now the servants of righteousness
whereby reminding christians of the importance of the cross and the blood of jesus.

10. A process method of claim 1, wherein to remind christians of the alabaster box woman, further comprising;
a. seeing and hearing a memorial video of the woman washing jesus feet by said christians
b. reminding ministers and pastors to preach of this woman as requested by jesus
c. hearing and seeing the word of god repeatedly by said christians
whereby reminding christians of the alabaster box woman and for ministers to preach all over the world of said woman as jesus requested.

11. A process method of claim 2, wherein for christians to pull down and urge the lord to appear, further comprising:
a. calling on the lord repeatedly by said holy christians of said denominations
b. calling on the lord repeatedly by righteous christians of said denominations
c. calling on the lord repeatedly by new christians of all ages of said denominations
d. calling on the lord morning, noon and night by christians of said denominations
e. calling on the lord and saying for the lord is good and his mercy endureth forever and the lord is my god with thanks and praise by said christians of said denominations
f. producing mass energy by said christians calling on the lord of all said denominations causing the light to appear
whereby pulling the lord down by said energy, E=mc² urging him to appear by his people.
